(19) United States
(12) Patent Application Publication
(10) Pub. No.: US 2026/0117105 A1
(43) Pub. Date: Apr. 30, 2026

(54) POLISHING COMPOSITION HAVING EXCELLENT STORAGE STABILITY AND METHOD FOR PRODUCING SAME

(71) Applicant: NISSAN CHEMICAL CORPORATION, Tokyo (JP)

(72) Inventors: Hibiki ISHIJIMA, Funabashi-shi (JP); Yume EBIHARA, Funabashi-shi (JP); Shigeru MITSUI, Funabashi-shi (JP)

(73) Assignee: NISSAN CHEMICAL CORPORATION, Tokyo (JP)

(21) Appl. No.: 19/144,833

(22) PCT Filed: Sep. 27, 2024
(86) PCT No.: PCT/JP2024/034606

§ 371 Date: Jun. 30, 2025

(30) Foreign Application Priority Data
Sep. 27, 2023 (WO) PCT/JP2023/035232
May 27, 2024 (WO) PCT/JP2024/019443

(51) Int. Cl. C09K 3/14

(52) U.S. Cl. CPC C09K 3/1463; C09K 3/1409

(57) ABSTRACT

A polishing composition which is used for polishing a silicon wafer and can improve polishing speed and storage stability, containing an aqueous dispersion of silica particles, wherein the Rsp value, which is derived from relaxation times determined from pulsed NMR measurements of the aqueous dispersion of silica particles and pure water, is 0.01 or more and less than 0.15: Rsp=(Rav−Rb)/(Rb); and Rsp is an indicator that indicates the affinity of silica particles for water, Rav is the reciprocal of the relaxation time for an aqueous dispersion of silica particles in which the silica concentration is 5 mass %, and Rb is the reciprocal of the relaxation time for pure water.

### TECHNICAL FIELD

The present invention relates to a polishing composition using silica-based abrasive grains and a method of producing the same.

### BACKGROUND ART

Polishing compositions using silica-based abrasive grains are used to polish silicon wafers. A polishing composition generally contains silica-based abrasive grains in an aqueous medium such as water, and optionally further contains an alkaline compound, a water-soluble compound, a chelating agent, an oxidizing agent, a metal corrosion inhibitor and the like.

A polishing composition that is defined using a function indicating affinity with water, which is calculated from the relationship between the reciprocal of a pulsed NMR relaxation time in a dispersion state of silica abrasive grains and a total surface area of the silica abrasive grains in order to shorten the polishing time with a high polishing rate, has been disclosed (refer to Patent Document 1).

In addition, a polishing composition in which the relationship between a BET specific surface area of silica particles contained as abrasive grains and a specific surface area measured by a pulsed NMR method is defined has been disclosed (refer to Patent Document 2).

In addition, a polishing composition in which the NMR relaxation time is evaluated using solvent affinity of abrasive grains has been disclosed (refer to Patent Documents 3 and 4).

A polishing composition in which the pulsed NMR measurement value Rsp=(Rav−Rb)/(Rb) of a dispersion of silica particles is 0.15 to 0.7, the shape factor SF1=(area of a circle whose diameter is the maximum diameter of the particle)/(projected area) of the silica particles is 1.20 to 1.80, and thus the polishing rate is improved, and the polished surface becomes favorable has been disclosed (refer to Patent Document 5).

### PRIOR ART DOCUMENTS

### Patent Documents

Patent Document 1: WO 2018/116890 A1
Patent Document 2: WO 2015/152151 A1
Patent Document 3: JP 2017-117894
Patent Document 4: WO 2018/012174 A1
Patent Document 5: WO 2020/091000 A1

### SUMMARY OF THE INVENTION

### Problem to be Solved by the Invention

An object of the present invention is to provide a polishing composition which achieves a high polishing rate when used to polish silicon wafers and has improved storage stability during storage or transportation.

The inventors have focused on the amount of water molecules bound to the surfaces of silica particles using the Rsp value derived from the relaxation time obtained by pulsed NMR measurement as an index, and found that, when silica particles having the Rsp value in a predetermined range are used as abrasive grains, the storage stability of the polishing composition is improved while maintaining high polishing performance.

### Means for Solving the Problem

The present invention provides, as a first aspect, a polishing composition comprising a silica particle aqueous dispersion, wherein the following Rsp value derived from a relaxation time obtained by pulsed NMR measurement of the silica particle aqueous dispersion and pure water is 0.01 or more and less than 0.15:

Rsp=(Rav−Rb)/(Rb)
wherein Rav is a reciprocal of the relaxation time of the silica particle aqueous dispersion having a silica concentration of 5% by mass, and Rb is a reciprocal of the relaxation time of the pure water,
as a second aspect, the polishing composition according to the first aspect, wherein the silica particles have an average secondary particle diameter of 40 to 200 nm, which is measured by a dynamic light scattering method, and an average primary particle diameter of 20 to 100 nm, which is measured by a nitrogen gas adsorption method,
as a third aspect, the polishing composition according to the first aspect, wherein, regarding a silica particle powder obtained by freezing a treatment solution in which ions are exchanged by bringing a cation exchange resin, an anion exchange resin, and a cation exchange resin into contact with the silica particle aqueous dispersion in an order of the cation exchange resin, the anion exchange resin, and the cation exchange resin at −70° C. to −80° C., additionally performing freeze-drying at room temperature under a pressure of 5 Pa or less, and removing a dispersion medium, a silanol group amount calculated from a mass loss amount when heated from room temperature to 700° C. in thermogravimetric analysis and a molecular weight of water molecules using the following formula is 0.1 to 1.5 mmol/g:

$$silanol group amount ( m mol / g ) = 2 \times ( M 2 - M 1 ) \div {M}_{H 2 O} \div ( M 0 - M 1 ) \times 1000$$

wherein M0 is a mass of a silica particle powder subjected to thermogravimetric analysis before heating, M1 is a mass loss amount when a temperature reaches 200° C., M2 is the mass loss amount when the temperature reaches 700° C., and M_{H2O} is the molecular weight of water molecules,
as a fourth aspect, the polishing composition according to the first aspect, wherein, in a silica particle powder obtained by freezing a treatment solution in which ions are exchanged by bringing a cation exchange resin, an anion exchange resin, and a cation exchange resin into contact with the silica particles in an order of the cation exchange resin, the anion exchange resin, and the cation exchange resin at −70° C. to −80° C., additionally performing freeze-drying at room temperature under a pressure of 5 Pa or less, and removing a dispersion medium, a density measured by dry density measurement is 2.20 to 2.35 g/cm³,
as a fifth aspect, the polishing composition according to the first aspect, wherein, regarding a silica particle powder obtained by heating a treatment solution in which ions are exchanged by bringing a cation exchange resin, an anion exchange resin, and a cation exchange resin into contact with the silica particle aqueous dispersion in an order of the cation exchange resin, the anion exchange resin, and the cation exchange resin at 140° C. for 2 hours, additionally performing heating at 290° C. for 1 hour, and removing a dispersion medium, a ratio (S_{H2O}/S_{N2}) of a specific surface area (S_{H2O}) based on a water vapor adsorption method to a specific surface area (S_{N2}) based on a nitrogen gas adsorption method is 0.10 to 0.65,
as a sixth aspect, the polishing composition according to any one of the first aspect to the fourth aspect, wherein the silica particle aqueous dispersion has a thermal history of being at a temperature of 140° C. or higher and lower than 260° C.,
as a seventh aspect, the polishing composition according to any one of the first aspect to the fifth aspect, wherein concentration of the silica particles is 1 to 40% by mass,
as an eighth aspect, the polishing composition according to any one of the first aspect to the seventh aspect, further comprising at least one additive selected from the group consisting of an acidic compound, a basic compound, a water-soluble compound, a chelating agent, an oxidizing agent, and a metal corrosion inhibitor,
as a ninth aspect, the polishing composition according to the eighth aspect, wherein the basic compound is at least one basic compound selected from the group consisting of alkali metal hydroxides, alkali metal carbonates, alkali metal bicarbonates, and nitrogen-containing basic compounds,
as a tenth aspect, the polishing composition according to the eighth aspect, wherein the chelating agent is an aminocarboxylic acid-based chelating agent or a phosphonic acid-based chelating agent,
as an eleventh aspect, the polishing composition according to any one of the first aspect to the tenth aspect, wherein the polishing composition has a pH of 1 to 12,
as a twelfth aspect, the polishing composition according to any one of the first aspect to the eleventh aspect,
wherein, in a test in which the polishing composition is heated and stored at 50° C. for 28 days,
a rate of increase in the average secondary particle diameter of the polishing composition after heating and storing at 50° C. for 28 days, which is measured by a dynamic light scattering method, compared to the average secondary particle diameter of the polishing composition before heating and storing at 50° C. for 28 days, which is measured by a dynamic light scattering method, is less than 5%,
as a thirteenth aspect, the polishing composition according to any one of the first aspect to the twelfth aspect, wherein the polishing composition is used to polish silicon wafers or device wafers,
as a fourteenth aspect, a method of producing the polishing composition according to any one of the first aspect to the thirteenth aspect, comprising:
a step of preparing a colloidal silica dispersion as a precursor; and
a step of obtaining the silica particle aqueous dispersion by heating the precursor at a temperature of 140° C. or higher and lower than 260° C.,
as a fifteenth aspect, a silica particle dispersion comprising a solvent and silica particles, wherein the following Rsp value derived from a relaxation times obtained by pulsed NMR measurement of the silica particle dispersion and a blank solution is 0.01 or more and less than 0.15:

$$Rsp = ( R a v - Rb ) / ( Rb )$$

wherein Rav is a reciprocal of the relaxation time of the silica particle dispersion having a silica concentration of 5% by mass, and Rb is a reciprocal of the relaxation time of the blank solution,
as a sixteenth aspect, the silica particle dispersion according to the fifteenth aspect, wherein the solvent includes water,
as a seventeenth aspect, the silica particle dispersion according to the fifteenth aspect, wherein the silica particles have an average secondary particle diameter of 40 to 200 nm, which is measured by a dynamic light scattering method, and an average primary particle diameter of 20 to 100 nm, which is measured by a nitrogen gas adsorption method,
as an eighteenth aspect, the silica particle dispersion according to the fifteenth aspect, wherein, regarding a silica particle powder obtained by freezing a treatment solution in which ions are exchanged by bringing a cation exchange resin, an anion exchange resin, and a cation exchange resin into contact with the silica particle dispersion in an order of the cation exchange resin, the anion exchange resin, and the cation exchange resin at −70° C. to −80° C., additionally performing freeze-drying at room temperature under a pressure of 5 Pa or less, and removing a dispersion medium, a silanol group amount calculated from a mass loss amount when heated from room temperature to 700° C. in thermogravimetric analysis and a molecular weight of water molecules using the following formula is 0.1 to 1.5 mmol/g:

$$silanol group amount ( m mol / g ) = 2 \times ( M 2 - M 1 ) \div {M}_{H 2 O} \div ( M 0 - M 1 ) \times 1000$$

wherein M0 is a mass of a silica particle powder subjected to thermogravimetric analysis before heating, M1 is a mass loss amount when a temperature reaches 200° C., M2 is the mass loss amount when the temperature reaches 700° C., and M_{H2O} is the molecular weight of water molecules,
as a nineteenth aspect, the silica particle dispersion according to the fifteenth aspect, wherein, in a silica particle powder obtained by freezing a treatment solution in which ions are exchanged by bringing a cation exchange resin, an anion exchange resin, and a cation exchange resin into contact with the silica particle dispersion in an order of the cation exchange resin, the anion exchange resin, and the cation exchange resin at −70° C. to −80° C., additionally performing freeze-drying at room temperature under a pressure of 5 Pa or less, and removing a dispersion medium, a density measured by dry density measurement is 2.20 to 2.35 g/cm³,
as a twentieth aspect, the silica particle dispersion according to the fifteenth aspect, wherein, regarding a silica particle powder obtained by heating a treatment solution in which ions are exchanged by bringing a cation exchange resin, an anion exchange resin, and a cation exchange resin into contact with the silica particle dispersion in an order of the cation exchange resin, the anion exchange resin, and the cation exchange resin at 140° C. for 2 hours, additionally performing heating at 290° C. for 1 hour, and removing a dispersion medium, a ratio (S_{H2O}/S_{N2}) of a specific surface area (S_{H2O}) based on a water vapor adsorption method to a specific surface area (S_{N2}) based on a nitrogen gas adsorption method is 0.10 to 0.65,
as a twenty-first aspect, the silica particle dispersion according to any one of the fifteenth aspect to the twentieth aspect, wherein the silica particle dispersion has a thermal history of being at a temperature of 140° C. or higher and lower than 260° C.,
as a twenty-second aspect, the silica particle dispersion according to any one of the fifteenth aspect to the twentieth aspect, wherein concentration of the silica particles is 1 to 40% by mass, and
as a twenty-third aspect, a method of producing the silica particle dispersion according to any one of the fifteenth aspect to the twenty-second aspect, comprising:
a step of preparing a colloidal silica dispersion as a precursor; and
a step of obtaining the silica particle dispersion by heating the precursor at a temperature of 140° C. or higher and lower than 260° C.

### Effects of the Invention

The present invention focuses on the amount of water molecules bound to the surfaces of silica particles using the Rsp value derived from the relaxation times obtained by pulsed NMR measurement of a dispersion in which silica particles used as abrasive grains are dispersed in an aqueous medium used in a polishing composition and pure water as an index, and it is found that, when the Rsp value has a specific value, a high polishing rate can be achieved and the storage stability of the polishing composition can be improved.

Since a high (fast) polishing rate leads to improved wafer production efficiency, it is required to achieve a high polishing rate for the polishing composition. In addition, when the storage stability of the silica particles contained in the polishing composition is poor, since the silica particles aggregate during storage or transportation and generate minute contaminants, which may cause a decrease in the polishing rate and the occurrence and increase of defects during polishing, high storage stability is also required.

The polishing composition contains silica particles as polishing abrasive grains. Depending on the surface state of the silica particles, the interaction between the surfaces of the particles and the aqueous medium in the polishing composition changes, and the change in the interaction affects the polishing rate and storage stability of the polishing composition.

In the silica particles as polishing abrasive grains in the polishing composition, water present on the surfaces of the particles or therearound is classified into bound water and free water according to the state. Free water is water that is present around silica particles but does not interact with the silica particles and remains in a free state. On the other hand, bound water is water that is hydrogen-bonded to silica particles through silanol groups on the surfaces of the silica particles. This bound water plays an important role in securing satisfactory contact between the silica particles and water.

The state (behavior) of water molecules can be determined from the relaxation time of protons of the water molecules by pulsed NMR measurement.

The relaxation mechanism in nuclear magnetic resonance (NMR) includes a process of releasing absorbed energy and a process of dephasing precession of aligned nuclear spins, and the former is called spin-lattice relaxation (longitudinal relaxation), and the relaxation time thereof is defined as T1, and the latter is called spin-spin relaxation (transverse relaxation), and the relaxation time thereof is defined as T2.

In the T1 relaxation, relaxation is most likely to occur when the molecular motion speed is comparable to the resonance frequency. For example, free water molecules that are not in contact with silica particles (free water) and water molecules that are in contact with silica particles (bound water) have different response times to a change in magnetic field, that is, have different relaxation times. In this case, a shorter relaxation time is considered to indicate a larger surface of the particles in contact with water and higher dispersibility of the particles.

In addition, in the T2 relaxation, relaxation occurs due to magnetic interactions. The measurement of relaxation time by pulsed NMR can be called a measurement method using the difference in T2 relaxation.

The presence of this bound water within a specific range effectively functions a polishing rate and storage stability during polishing.

In the present invention, when the affinity between the silica particles as polishing abrasive grains and the aqueous medium in the polishing composition is precisely controlled, it is possible to achieve both an improvement in polishing rate and an improvement in storage stability, particularly in silicon wafer polishing.

### MODES FOR CARRYING OUT THE INVENTION

Hereinafter, the present invention will be described in detail. Here, in the present invention, silica particle dispersions are dispersions of silica particles in water or an organic solvent, or in a mixed solvent containing water and an organic solvent, a silica particle aqueous dispersion in which silica particles are dispersed in water, a silica particle organic solvent dispersion in which silica particles are dispersed in an organic solvent, and a silica particle mixed solvent dispersion in which silica particles are dispersed in a mixed solvent containing water and an organic solvent are called colloidal silica dispersions or silica sols, and silica particles are sometimes called colloid type silica (colloidal silica).

### <Rsp Value>

The present invention refers to a polishing composition containing a silica particle aqueous dispersion, in which the following Rsp value derived from the relaxation times obtained by pulsed NMR measurement of the silica particle aqueous dispersion and pure water is 0.01 or more and less than 0.15, and the present invention also refers to a silica particle dispersion containing a solvent and silica particles, in which the following Rsp value derived from the relaxation times obtained by pulsed NMR measurement of the silica particle dispersion and the solvent (for example, pure water) is 0.01 or more and less than 0.15.

$$Rsp = ( R a v - Rb ) / ( Rb )$$

The Rsp value is an index indicating the affinity of silica particles to a solvent, particularly, the affinity to water molecules, Rav is the reciprocal of the relaxation time of a silica particle dispersion having a silica concentration of 5% by mass (for example, a silica particle aqueous dispersion), and Rb is the reciprocal of the relaxation time of the solvent (for example, pure water).

The Rsp value may be, for example, 0.03 to less than 0.15, 0.05 to less than 0.15, 0.01 to 0.14, 0.03 to 0.14, 0.05 to 0.14, or 0.07 to 0.14.

When the Rsp value is 0.01 or more, since the silica particles have appropriate water affinity, they can maintain dispersibility in a solvent or a polishing composition. In addition, when Rsp is less than 0.15, there are few hydroxy groups (OH⁻) of water molecules bound near the surfaces of the silica particles, and when the polishing composition is formed, it is possible to minimize excessive dissolution of the surfaces of the silica particles caused by the hydroxy group. As a result, the aggregation of the silica particles in an aqueous medium (water) is minimized, and when the polishing composition containing the silica particles is used to polish silicon wafers, the polishing rate is improved, and the storage stability of the polishing composition is improved.

The measurement principle of this method (pulsed NMR) is based on the difference in the response to a change in the magnetic field between solvent molecules that are in contact with or adsorbed on the surfaces of the particles and solvent molecules in a bulk solvent (free solvent molecules that are not in contact with the surfaces of the particles).

When a change in the magnetic field is applied to liquid molecules, energy transfer occurs when the liquid molecules transition from an excited state to a ground state. Generally, energy transfer occurs in liquid molecules (solvent molecules) adsorbed on the surfaces of the particles through the particles, but energy transfer is unlikely to occur in liquid molecules (solvent molecules) in a bulk liquid because there is no intermediate. As a result, the NMR relaxation time of liquid molecules (solvent molecules) adsorbed on the surfaces of the particles is shorter than the relaxation time of the molecules in the bulk liquid.

In addition, the relaxation time measured in a silica particle dispersion (for example, a silica particle aqueous dispersion) is the average value of two relaxation times reflecting the volume concentration of the liquid on the surfaces of the silica particles and the volume concentration of the free liquid (liquid that is in the bulk liquid but not adsorbed on the surfaces of the particles).

Here, the relaxation time constant R is the reciprocal of the relaxation time T, and is calculated as follows:

$$Rav = ( Ps * Rs ) + ( Pb * Rb )$$

Rav: the average relaxation time constant, that is, the reciprocal of the relaxation time of the silica particle dispersion (for example, a silica particle aqueous dispersion).
Ps: the volume concentration of the liquid on the surfaces of the particles, that is, the volume concentration of the silica particle dispersion (for example, a silica particle aqueous dispersion).
Rs: the relaxation time constant of liquid molecules adsorbed on the surfaces of the particles, that is, the reciprocal of the relaxation time of liquid molecules adsorbed on the surfaces of the particles.
Pb: the volume concentration of a bulk liquid, that is, the volume concentration of a blank solution (in the present invention, for example, in the case of an aqueous dispersion, pure water is used, and in the case of an organic solvent dispersion or a mixed solvent dispersion containing water and an organic solvent, a solvent with the same composition ratio as the contained solvent is used) excluding silica particles in a silica particle dispersion (for example, a silica particle aqueous dispersion).
Rb: the relaxation time constant of bulk liquid molecules, that is, the reciprocal of the relaxation time of the blank solution (for example, pure water).

The pulsed NMR measurement value of the silica particle dispersion (for example, a silica particle aqueous dispersion) is calculated as Rsp=(Rav−Rb)/(Rb).

Rav and Rb are the reciprocals of the relaxation times (transverse relaxation time T2, specifically, the NMR relaxation time after silica abrasive grains are dispersed, and the NMR relaxation time of the blank solution (for example, pure water)) measured using a pulsed NMR device (product name, Acorn area, commercially available from Xigo nanotools).

The measurement conditions may be as follows: magnetic field: 0.3 T, measurement frequency 13 MHz, measurement nucleus: ¹H NMR, measurement method: CPMG pulse sequence method, sample volume 0.77 mL, and temperature: 30° C.

Rsp is an index of affinity of the surfaces of the particles with a solvent. Here, when silica particles have the same specific surface area, a larger value (Rsp) indicates higher affinity with the solvent, and indicates higher hydrophilicity particularly when the solvent is aqueous.

### <Particle Diameter<Average Primary Particle Diameter and Average Secondary Particle Diameter>>

The average primary particle diameter of a colloidal silica dispersion is the average primary particle diameter of the silica particles that are dispersoids.

In the present invention, unless otherwise specified, the average primary particle diameter of the colloidal silica dispersion (silica particles) is the particle diameter calculated from the specific surface area obtained by measurement using a nitrogen gas adsorption method (BET method).

The specific surface area diameter (average particle diameter (specific surface area diameter) D(nm)) obtained by measurement using the nitrogen gas adsorption method (BET method) is determined by the formula D(nm)=2720/S from the specific surface area S (m²/g) measured using the nitrogen gas adsorption method.

In the present invention, the average primary particle diameter of the silica particles is, for example, 20 to 100 nm, and may be, for example, 20 to 85 nm, 30 to 70 nm, or 35 to 60 nm. When the average primary particle diameter of the silica particles is 20 nm or more, the silica particles come into contact with both a silicon wafer and a polishing pad when used to polish the silicon wafer, and thus the polishing rate can be improved. In addition, since the distance the silica particles travel by the Brownian motion can be prevented from becoming excessively large, it is possible to reduce the frequency of contact between silica particles in the polishing composition and improve the storage stability. When the average primary particle diameter of the silica particles is 100 nm or less, it is possible to reduce the occurrence of defects caused by scratches that occur when silica particles are rubbed against the surface of a silicon wafer when used to polish the silicon wafer. In addition, since the silica particles are prevented from precipitating in the polishing composition and the silica particles are prevented from adhering to each other at the bottom of a storage container, the storage stability of the polishing composition is improved.

Here, the average secondary particle diameter and the dispersion state (whether the silica particles are dispersed or aggregated) of the silica particles in the silica particle dispersion or the polishing composition can be determined by measurement using a dynamic light scattering method.

It is said that the average secondary particle diameter is the average value of the secondary particle diameters (dispersed particle diameters), and the average secondary particle diameter when the particles are completely dispersed is about 1.2 to 2 times the average primary particle diameter (which indicates a specific surface area diameter obtained by measurement using a nitrogen gas adsorption method (BET method) or a Sears method, and an average value of primary particle diameters). In addition, as the value of the average secondary particle diameter/average primary particle diameter increases, it can be determined that the silica particles in the medium are in an aggregation state.

In the present invention, the average secondary particle diameter of silica particles, that is, for example, a colloidal silica dispersion (colloidal silica particles), determined by the dynamic light scattering method may be, for example, 40 to 200 nm, or 40 to 150 nm, 40 to 100 nm, or 50 to 80 nm. When the average secondary particle diameter is within the above range, it is possible to minimize the aggregation of silica particles in the polishing composition. As a result, it is possible to further improve the polishing rate when used to polish silicon wafers, and it is possible to improve the storage stability of the polishing composition. Here, in the present invention, the average secondary particle diameter of the silica particles determined by the dynamic light scattering method is measured using a Zetasizer Nano (product name, commercially available from Malvern Panalytical Ltd.) device according to ISO 22412:2017. In addition, the average secondary particle diameter is the Z average particle diameter measured by the dynamic light scattering method.

### <Polyvalent Metal Impurities>

In the polishing composition containing a silica particle aqueous dispersion of the present invention, the amount of polyvalent metal impurities contained in the polishing composition may be 1 to 100 ppm/SiO₂, 1 to 50 ppm/SiO₂, or 1 to 40 ppm/SiO₂.

In the silica particle dispersion of the present invention, the amount of polyvalent metal impurities contained in the silica particle dispersion may be 1 to 100 ppm/SiO₂, 1 to 50 ppm/SiO₂, or 1 to 40 ppm/SiO₂.

When the amount of polyvalent metal impurities contained in the polishing composition is within the above range, it is possible to minimize changes in the pH or electrolyte concentration of the polishing composition due to elution of polyvalent metal impurities from the inside of the silica particles or deterioration of the dispersion stability of the silica particles due to cationized polyvalent metals in the polishing composition acting as silica particle aggregating agents.

When the amount of polyvalent metal impurities contained in the silica particle dispersion is within the above range, it is possible to minimize changes in the pH or electrolyte concentration of the silica particle dispersion due to elution of polyvalent metal impurities from the inside of the silica particles or deterioration of the dispersion stability of the silica particles due to cationized polyvalent metals in the silica particle dispersion acting as silica particle aggregating agents.

In addition, when the amount of polyvalent metal impurities contained in the silica particle dispersion is the above range, it is possible to control the amount of polyvalent metal impurities contained in the silica particles, the network of Si—O—Si bonds that constitute the framework of the silica particles becomes dense, and it is possible to minimize excessive dissolution of the surfaces of the silica particles caused by the hydroxy group. As a result, it is possible to further improve the polishing rate when used to polish silicon wafers, and it is possible to improve the storage stability of the polishing composition.

Examples of polyvalent metal impurities include iron, aluminum, calcium, magnesium, titanium, zirconium, copper, nickel, chromium, zinc, and lead. The amount of polyvalent metal impurities can be analyzed by performing a pretreatment on a polishing composition or silica particle dispersion, completely dissolving silica particles contained in the composition or dispersion, and then subjecting them to inductively coupled plasma optical emission spectroscopy (ICP-OES), inductively coupled plasma mass spectrometry (ICP-MS), atomic absorption spectrometry (AA) or the like.

The pretreatment for dissolving silica particles can be performed, for example, by the following steps. 36 mL of a 38% by mass hydrofluoric acid aqueous solution, 6 mL of 61% by mass nitric acid and 0.3 mL of 96% by mass sulfuric acid are added to 1 g of silica particles contained in the polishing composition or silica particle dispersion, the obtained mixed solution is treated using a microwave type sample pretreatment device at 210° C. for 15 minutes to dissolve the silica particles, and the decomposition solution is then collected. The collected decomposition solution is heated at 120° C. under atmospheric pressure until the solvent evaporates and is dried to obtain a dried product. 0.3 mL of 61% by mass nitric acid is added to the obtained dried product, pure water is then added so that the total mass of the dried product, nitric acid and pure water is 3 g, and thereby a sample for metal impurity amount analysis is obtained.

### <Silanol Group Amount>

The silica particles contained in the polishing composition or silica particle dispersion of the present invention may contain a predetermined silanol group amount. That is, regarding a silica particle powder obtained by freeze-drying a colloidal silica dispersion containing the silica particles at room temperature under a pressure of 5 Pa or less and removing a dispersion medium, the silanol group amount calculated from a mass loss amount when heated from room temperature to 700° C. in thermogravimetric analysis and a molecular weight of water molecules using the following formula may be, for example, 0.1 to 1.5 mmol/g, 0.3 to 1.5 mmol/g, 0.5 to 1.5 mmol/g, 0.3 to 1.4 mmol/g, 0.5 to 1.4 mmol/g, 0.3 to 1.3 mmol/g, or 0.3 to 1.3 mmol/g.

$$Silanol group amount ( m mol / g ) = 2 \times ( M 2 - M 1 ) \div {M}_{H 2 O} \div ( M 0 - M 1 ) \times 1000$$

Here, M0 is the mass of a silica particle powder subjected to thermogravimetric analysis before heating, M1 is the mass loss amount when the temperature reaches 200° C., M2 is the mass loss amount when the temperature reaches 700° C., and M_{H2O} is the molecular weight of water molecules.

Here, in order to obtain the silica particle powder by freeze-drying, a target silica particle dispersion is first brought into contact with a cation exchange resin, an anion exchange resin, and a cation exchange resin in that order to obtain an ion exchange treatment solution. The ion-exchanged solution is frozen at −70° C. to −80° C. and freeze-dried at room temperature under a pressure of 5 Pa or less, the dispersion medium is removed, and thereby a desired silica particle powder can be obtained.

Silica particles have silanol groups on their surfaces, and the silanol groups easily adsorb water through hydrogen bonds. Therefore, in order to quantify the silanol group amount of silica particles from the mass loss amount due to heating, as described above, it is preferable to remove adsorbed water by heating to about 200° C. at which the adsorbed water is desorbed.

In addition, for example, when the silanol group amount of the silica particles is larger than 1.5 mmol/g, bonds between the particles are likely to occur when two silica particles come into contact with each other, and the stability of the polishing composition or silica particle dispersion deteriorates. For example, when the silanol group amount of the silica particles is smaller than 0.1 mmol/g, since the surfaces of the silica particles are not sufficiently solvated in a polar solvent, and thus the silica particles cannot maintain the dispersibility but aggregate and precipitate, the stability of the polishing composition or silica particle dispersion deteriorates.

### <Density>

The silica particles contained in the polishing composition or silica particle dispersion of the present invention can have a predetermined density. That is, in a silica particle powder obtained by freeze-drying a colloidal silica dispersion containing the silica particles at room temperature under a pressure of 5 Pa or less and removing a dispersion medium, the density measured by dry density measurement may be, for example, 2.20 to 2.35 g/cm³, 2.22 to 2.35 g/cm³, 2.25 to 2.35 g/cm³, 2.27 to 2.35 g/cm³, 2.25 to 2.33 g/cm³, 2.25 to 2.30 g/cm³, or 2.27 to 2.30 g/cm³.

Here, the procedure of obtaining the silica particle powder by freeze-drying is the same as the procedure that described for quantifying<Silanol group amount>.

When the density of the silica particles contained in the polishing composition or silica particle dispersion is 2.20 g/cm³ or more or 2.25 g/cm³ or more, the network of Si—O—Si bonds that constitute the framework of silica particles becomes dense, and adsorption and desorption of impurities such as metal ions are minimized, and thus it is possible to prevent deterioration of the dispersibility of the silica particles due to fluctuations in the pH, electrolyte concentration or composition balance of the polishing composition or silica particle dispersion. In addition, when the density of the silica particles contained in the polishing composition or silica particle dispersion is 2.35 g/cm³ or less, it is possible to minimize precipitation of the silica particles in the polishing composition or the silica particle dispersion, bonding of the silica particles together, and adhesion of the silica particles to the container. As a result, it is possible to further improve the polishing rate when used to polish silicon wafers, and it is possible to improve the storage stability of the polishing composition.

### <Ratio of Specific Surface Area Based on Water Vapor Adsorption Method To Specific Surface Area Based on Nitrogen Gas Adsorption Method>

The silica particles contained in the polishing composition or silica particle dispersion of the present invention may have a predetermined ratio of a specific surface area based on the water vapor adsorption method to a specific surface area based on the nitrogen gas adsorption method. That is, regarding a silica particle powder obtained by heating and drying a colloidal silica dispersion containing the silica particles under atmospheric pressure and removing the dispersion medium, the ratio (S_{H2O}/S_{N2}) of the specific surface area (S_{H2O}) based on the water vapor adsorption method obtained by BET analysis from the relationship between the water vapor adsorption amount and the relative humidity to the specific surface area (S_{N2}) based on the nitrogen gas adsorption method (BET method) described in <Particle diameter<average primary particle diameter and average secondary particle diameter>> may be, for example, 0.10 to 0.65, 0.15 to 0.65, 0.20 to 0.65, 0.10 to 0.60, 0.10 to 0.50, 0.10 to 0.40, 0.20 to 0.60, 0.25 to 0.60, 0.25 to 0.50 or 0.25 to 0.40. The specific surface area (S_{H2O}) based on the water vapor adsorption method can be determined by performing BET analysis on the water vapor adsorption amount of the silica particles measured using a water vapor adsorption and desorption measurement device and the relative humidity in a relative humidity range of 0.20 to 0.35.

Here, in order to obtain the silica particle powder by heating and drying, a target silica particle dispersion is first brought into contact with a cation exchange resin, an anion exchange resin, and a cation exchange resin in that order to obtain an ion exchange treatment solution. The ion-exchanged solution is heated at 140° C. for 2 hours to remove most of the dispersion medium, and then heated at 290° C. for 1 hour to completely remove the dispersion medium, crushing is performed in a mortar for 10 minutes, and thereby a desired silica particle powder can be obtained.

As in the quantifying of <Silanol group amount>, silica particles have silanol groups on their surfaces, and the silanol groups easily adsorb water through hydrogen bonds. Therefore, in order to quantify the specific surface area based on the water vapor adsorption method, as described above, it is preferable to remove adsorbed water by heating at 200° C. at which the adsorbed water is desorbed for 1 hour immediately before the measurement.

In addition, for example, when the ratio of the specific surface area based on the water vapor adsorption method to the specific surface area based on the nitrogen gas adsorption method is larger than 0.65, the surfaces of the silica particles are highly hydrophilic, many hydroxy groups (OH⁻) in the composition are adsorbed on the surfaces of the particles, the silanol bonds on the surfaces of the silica particles are cleaved, and dissolution may progress. When the dissolution of the silica particles progresses, highly active silanol groups in the silica particles are exposed on the surfaces of the silica particles, the aggregation of the silica particles progresses, and there is a risk of the storage stability of the polishing composition or silica particle dispersion deteriorating. On the other hand, for example, when the ratio is smaller than 0.10, since the surfaces of the silica particles have low hydrophilicity, the silica particles are not sufficiently solvated in a polar solvent, and thus the silica particles cannot maintain the dispersibility but aggregate and precipitate, there is a risk of the stability of the polishing composition or silica particle dispersion deteriorating.

### <Production of Silica Particle Dispersion>

The method of producing a colloidal silica dispersion (silica sol) used in the present invention can be broadly divided into a step (I) of obtaining activated silicic acid, a step (II) of preparing a precursor silica sol, a step (III) of additionally heating the precursor silica sol, and a step (IV) of concentrating the obtained silica sol.

### <<Step (I)>>

The step (I) of obtaining activated silicic acid is divided into a step (a1) of obtaining activated silicic acid and a step (a2) of highly purifying the activated silicic acid. Among these, the step (a1) is essential, and the step (a2) is not essential but is optionally performed.

For example, the step (a1) and step (a2) can be performed as follows.
Step (a1): An alkali metal silicate aqueous solution containing a percentage of 300 to 10,000 ppm of metal oxides other than silica to silica is diluted with pure water to a concentration of 1 to 6% by mass in terms of SiO₂ derived from the silicate, and then brought into contact with a hydrogen-type strongly acidic cation exchange resin, and thereby an aqueous solution containing activated silicic acid having a SiO₂ concentration of 1 to 6% by mass is obtained.
Step (a2): For example, an acid selected from among mineral acids such as hydrochloric acid, sulfuric acid, nitric acid, and phosphoric acid is added to the activated silicic acid aqueous solution obtained in the step (a1), the pH is adjusted to 1 to 2, and the sample is left for 12 hours or longer. Therefore, metal oxides other than silica are dissolved and ionized, the solution is then brought into contact with a hydrogen-type strongly acidic cation exchange resin to remove the dissolved metal ions, the solution is then brought into contact with a hydroxyl group-type strongly basic anion exchange resin, and thereby purified activated silicic acid from which anions have been removed and which has a SiO₂ concentration of 1 to 6% by mas is obtained.

In the step (a1), it is preferable to use, as the alkali metal silicate, sodium water glass which is inexpensive industrial product and has a SiO₂/Na₂O molar ratio of about 2 to 4. As impurities contained in the water glass, main polyvalent metals that are relatively abundant include aluminum, iron, calcium, magnesium and the like.

The alkali metal silicate aqueous solution can preferably be brought into contact with the hydrogen-type strongly acidic cation exchange resin by passing the alkali metal silicate aqueous solution through a column filled with the ion exchange resin. The liquid passing through the column is collected as an activated silicic acid aqueous solution having a SiO₂ concentration of 1 to 6% by mass, preferably 2 to 6% by mass.

The amount of the hydrogen type cation exchange resin used may be an amount sufficient to exchange the total amount of alkali metal ions in the alkali metal silicate aqueous solution with hydrogen ions, and specifically, preferably an amount such that the exchange capacity of the hydrogen type cation exchange resin is 1 to 5 times, 1 to 3 times, or 1 to 2 times the total amount of alkali metal ions contained in the alkali metal silicate aqueous solution on an equivalent basis. The speed of passing through the column is preferably a space velocity of about 1 to 10 per hour.

### <<Step (II)>>

The step (II) of preparing a precursor silica sol is, for example, a step of performing the following step (b) and step (c), or a step of preparing a commercially available silica sol.
Step (b): An aqueous solution containing sodium or potassium hydroxide is added to the activated silicic acid aqueous solution obtained in the step (I) to obtain a stabilized activated silicic acid aqueous solution having a SiO₂ concentration adjusted to 1 to 6% by mass and a pH adjusted to 7 to 10.
Step (c): The activated silicic acid aqueous solution collected in the step (b) is heated with sufficient stirring at a temperature kept at 110 to lower than 160° C., 110 to 150° C., 120 to 150° C., or 130 to 150° C. for 0.5 to 30 hours to obtain a precursor silica sol.

Here, the sodium hydroxide or potassium hydroxide aqueous solution used in the step (b) is preferably obtained by dissolving commercially available industrial sodium hydroxide or potassium hydroxide with a purity of 95% by mass or more in industrial water or deionized water from which cations have been removed to a concentration of preferably 2 to 20% by mass.

In addition, the device used in the step (c) may be a general acid-resistant, alkali-resistant and pressure-resistant container including a stirrer, a temperature control device, a liquid level detection device, a pressure reducing device, a liquid supply device, the cooling device and the like.

Here, in the step (c), the liquid temperature in the container is kept at 110 to lower than 160° C.

### <<Step (III)>>

The step (III) of additionally heating the precursor silica sol includes the following step (d), step (e) and step (f). Among the above steps, the step (f) is essential, and the step (d) and the step (e) are not essential but are optionally performed.

The step (d) or the step (e) can be performed before the step (f). Either the step (d) or the step (e) may be performed or both may be performed or neither may be performed. When both are performed, either the step (d) or the step (e) may be performed first.
Step (d): The precursor silica sol obtained in the step (II) or the precursor silica sol with an adjusted pH obtained in the following step (e) is concentrated to a SiO₂ concentration of 10 to 40% by mass using a known concentration device such as a concentrator including an ultrafiltration membrane or a vacuum concentrator.
Step (e): A basic compound is added to a product liquid obtained by bringing the precursor silica sol obtained in the step (II) or the precursor silica sol with an adjusted SiO₂ concentration obtained in the step (d) into contact with a hydrogen-type strongly acidic cation exchange resin, and the pH is adjusted to 7 to 10.

Step (f): The precursor silica sol obtained in the step (II), the precursor silica sol with an adjusted SiO₂ concentration obtained in the step (d) or the precursor silica sol with an adjusted pH obtained in the step (e) is heated with sufficient stirring at a temperature kept at, for example, 140 to lower than 300° C., 160 to 280° C., 160 to 260° C., 160 to 240° C., 170 to 240° C., 180 to 240° C., or 190 to 240° C. for 0.5 to 30 hours to obtain a silica sol.

Here, in the step (f), the liquid temperature in the container is kept at 160 to lower than 300° C.

### <<Step (IV)>>

The step (IV) of additionally concentrating the obtained silica sol is a step of concentrating the silica sol obtained in the step (III) to 10 to 50% by mass. The step (IV) is not essential but is optionally performed. For the concentration, a known concentration device such as a concentrator including an ultrafiltration membrane or a vacuum concentrator can be used.

### <Additive>

The polishing composition of the present invention may further contain, in addition to silica particles as abrasive grains and water as an aqueous medium, at least one additive selected from the group consisting of an acidic compound, a basic compound, a water-soluble compound, a chelating agent, an oxidizing agent, and a metal corrosion inhibitor.

The silica particle dispersion of the present invention may further contain, in addition to silica particles and water or an organic solvent, or a mixed solvent containing water and an organic solvent, at least one additive selected from the group consisting of an acidic compound and a basic compound.

Here, the mass proportion of solids of the polishing composition excluding water as an aqueous medium may be, for example, 0.01 to 40% by mass, 0.01 to 30% by mass, 0.01 to 20% by mass, 0.1 to 40% by mass, 0.1 to 20% by mass, or 0.1 to 15% by mass, and the mass proportion of the silica particles in the solids may be 80 to 100% by mass, or 85 to 99.9% by mass. Furthermore, the mass proportion of the silica particles in the polishing composition or silica particle dispersion may be 1 to 40% by mass, 1 to 30% by mass, 1 to 20% by mass, or 3 to 30% by mass.

When the proportion of the solids of the polishing composition excluding the aqueous medium is 0.01% by mass or more, it is possible to minimize excessive dissolution of the surfaces of the silica particles caused by the hydroxy group. When the proportion of the solids of the polishing composition excluding the aqueous medium is 40% by mass or less, it is possible to prevent an increase in the number of silica particles in the polishing composition and an increase in the frequency of contact between silica particles due to a decrease in the amount of solvent and to minimize aggregation. In addition, since it is possible to prevent the viscosity of the polishing composition from excessively increasing, handling becomes easier. As a result, the storage stability of the polishing composition is improved, and it is easier to store or transport the polishing composition.

The amount of solids in the polishing composition or silica particle dispersion can be measured, for example, by heating the composition in an electric furnace at 1,000° C. for 1 hour, and weighing out the residue.

Examples of acidic compounds include mineral acids such as hydrochloric acid, sulfuric acid, nitric acid, and phosphoric acid, and organic acids such as formic acid, oxalic acid, citric acid, acetic acid, lactic acid, malic acid, malonic acid, succinic acid, tartaric acid, butyric acid, fumaric acid, benzoic acid, glycolic acid, propionic acid, and ascorbic acid. As the acidic compound, one selected from among the above examples may be used alone or a plurality (two or more) thereof may be used in combination.

Examples of basic compounds include alkali metal hydroxides, alkali metal carbonates, alkali metal bicarbonates and nitrogen-containing basic compounds. As the basic compound, one selected from among the above examples may be used alone or a plurality (two or more) thereof may be used in combination.

Among the above basic compounds, as the alkali metal hydroxide, it is preferable to use sodium hydroxide or potassium hydroxide. As the alkali metal bicarbonate, it is preferable to use sodium bicarbonate or potassium bicarbonate. As the alkali metal carbonate, it is preferable to use sodium carbonate or potassium carbonate. As the nitrogen-containing basic compound, it is preferable to use ammonia or a quaternary ammonium salt, and in order to achieve a high polishing rate, it is more preferable to use a quaternary ammonium compound. As the quaternary ammonium compound, tetramethylammonium hydroxide, ethyltrimethylammonium hydroxide, diethyldimethylammonium hydroxide, tetraethylammonium hydroxide, or tetramethylammonium hydroxide or salts thereof can be used. Among these, it is preferable to use tetraethylammonium hydroxide or salts thereof, and it is more preferable to use tetramethylammonium hydroxide or salts thereof.

The basic compound can be added to the polishing composition in an amount of, for example, 0.1 to 50% by mass, 0.1 to 30% by mass, 0.1 to 10% by mass, 1 to 50% by mass, 1 to 30% by mass, or 1 to 10% by mass, to the silica particles. When the amount of the basic compound added is within the above range, it is possible to prevent the pH of the polishing composition from increasing or decreasing excessively, and it is possible to improve the stability of the polishing composition.

When such an acidic compound or basic compound is added, the pH of the polishing composition according to the present invention can be adjusted to be within a range of 1 to 12, 1 to 6, 3 to 6, 7 to 12, 7 to 10, 8 to 11, or 10 to 12. If the pH of the polishing composition is within the above range, when the polishing composition is used to polish a silicon wafer, the Si bonds on the surface of the silicon wafer are broken with an acid or base, the surface of the silicon wafer is easily scraped off with the silica particles, and thus the polishing rate can be improved.

In addition, when such an acidic compound or basic compound is added, the pH of the silica particle dispersion according to the present invention can be adjusted to be within a range of 8 to 11, 8 to 10, or 9 to 10. Within the above range, it is possible to improve the dispersibility of the silica particles and minimize the aggregation of the silica particles in the solvent.

As the water-soluble compound, any water-soluble compound can be used. Examples thereof include monomers having a carboxylic acid group such as acrylic acid, methacrylic acid, and maleic acid, their polymers such as polyacrylic acid and polymethacrylic acid, and their salts such as ammonium polyacrylate, potassium polyacrylate, ammonium polymethacrylate, and potassium polymethacrylate. In addition, alginic acid, pectinic acid, carboxymethylcellulose, polyaspartic acid, polyglutamic acid, polyamic acid, ammonium polyamic acid, polyvinylpyrrolidone, hydroxyethyl cellulose, hydroxypropyl cellulose, glycerin, polyglycerin, polyvinyl alcohol, polyacrylamide and derivatives of the polyacrylamide, polymethacrylamide and derivatives of the polymethacrylamide, or carboxyl-group or sulfonic-acid-group modified polyvinyl alcohol can be used.

The water-soluble compound can be added to the polishing composition in an amount of, for example, 0.01 to 10% by mass, 0.01 to 5% by mass, 0.01 to 3% by mass, 0.05 to 10% by mass, 0.1 to 10% by mass, or 0.05 to 5% by mass, to the silica particles. When the amount of the water-soluble compound added is within the above range, it is possible to improve the dispersion stability of the silica particles contained in the polishing composition, and it is possible to improve the flatness of the silicon wafer by protecting the surface of the silicon wafer except for the convex parts where load is concentrated due to adhesion to the silicon wafer when the silicon wafer is polished.

As the chelating agent, an aminocarboxylic acid-based chelating agent or a phosphonic acid-based chelating agent can be used.

Examples of aminocarboxylic acid-based chelating agents include ethylenediaminetetraacetic acid, nitrilotriacetic acid, diethylenetriaminepentaacetic acid, hydroxyethylethylenediaminetriacetic acid, triethylenetetraminehexaacetic acid, 1,3-propanediaminetetraacetic acid, 1,3-diamine-2-hydroxypropanetetraacetic acid, hydroxyethyliminodiacetic acid, dihydroxyethylglycine, glycoletherdiaminetetraacetic acid, dicarboxymethylglutamic acid, and ethylenediamine-N,N′-disuccinic acid.

In addition, examples of phosphonic acid-based chelating agents include hydroxyethylidene diphosphonic acid, nitrilotris(methylene phosphonic acid), phosphonobutane tricarboxylic acid, and ethylenediaminetetra(methylene phosphonic acid).

The above-mentioned chelating agent can be added to the polishing composition in an amount of, for example, 0.01 to 10% by mass, 0.01 to 5% by mass, 0.01 to 3% by mass, 0.05 to 10% by mass, 0.1 to 10% by mass, or 0.05 to 5% by mass, to the silica particles. When the amount of the chelating agent added is within the above range, it is possible to reduce contamination of the silicon wafer with metal impurities and improve the dispersion stability of the silica particles contained in the polishing composition.

Examples of oxidizing agents include hydrogen peroxide, potassium permanganate, potassium periodate, hypochlorous acid, and ozone water.

The above-mentioned oxidizing agent can be added to the polishing composition in an amount of, for example, 0.01 to 10% by mass, 0.01 to 5% by mass, 0.01 to 3% by mass, 0.05 to 10% by mass, 0.1 to 10% by mass, or 0.05 to 5% by mass, to the silica particles. If the amount of the oxidizing agent added is within the above range, when the polishing composition is used to polish a silicon wafer, the surface of the silicon wafer is oxidized so that it becomes easier to scrape off with the silica particles, and the polishing rate is improved.

Examples of metal corrosion inhibitors include triazole compounds, pyridine compounds, pyrazole compounds, pyrimidine compounds, imidazole compounds, guanidine compounds, thiazole compounds, tetrazole compounds, triazine compounds, and hexamethylenetetramine.

Examples of triazole compounds include 1,2,3-triazole, 1,2,4-triazole, 3-amino-1H-1,2,4-triazole, benzotriazole (BTA), 1-hydroxybenzotriazole, 1-hydroxypropyl benzotriazole, 2,3-dicarboxypropyl benzotriazole, 4-hydroxybenzotriazole, 4-carboxy-1H-benzotriazole, 4-carboxy-1H-benzotriazole methyl ester(1H-benzotriazole-4-carboxylate methyl), 4-carboxy-1H-benzotriazole butyl ester(1H-benzotriazole-4-carboxylate butyl), 4-carboxy-1H-benzotriazole octyl ester(1H-benzotriazole-4-carboxylate octyl), 5-hexyl benzotriazole, (1,2,3-benzotriazolyl-1-methyl)(1,2,4-triazolyl-1-methyl)(2-ethylhexyl)amine, tolyltriazole, naphthotriazole, bis[(1-benzotriazolyl)methyl]phosphonic acid, 3H-1,2,3-triazolo[4,5-b]pyridin-3-ol, 1H-1,2,3-triazolo[4,5-b]pyridine, 1-acetyl-1H-1,2,3-triazolo[4,5-b]pyridine, 3-hydroxypyridine, 1,2,4-triazolo[1,5-a]pyrimidine, 1,3,4,6,7,8-hexahydro-2H-pyrimido[1,2-a]pyrimidine, 2-methyl-5,7-diphenyl-[1,2,4]triazolo[1,5-a]pyrimidine, 2-methylsulfanyl-5,7-diphenyl-[1,2,4]triazolo[1,5-a]pyrimidine, and 2-methylsulfanyl-5,7-diphenyl-4,7-dihydro-[1,2,4]triazolo[1,5-a]pyrimidine.

Examples of pyridine compounds include pyridine, 8-hydroxyquinoline, prothionamide, 2-nitropyridin-3-ol, pyridoxamine, nicotinamide, iproniazid, isonicotinic acid, benzo[f]quinoline, 2,5-pyridinedicarboxylic acid, 4-styrylpyridine, anabasine, 4-nitropyridine-1-oxide, pyridine-3-acetic acid ethyl, quinoline, 2-ethylpyridine, quinolinic acid, arecoline, citrazinic acid, pyridine-3-methanol, 2-methyl-5-ethylpyridine, 2-fluoropyridine, pentafluoropyridine, 6-methylpyridine-3-ol, and pyridine-2-acetic acid ethyl.

Examples of pyrazole compounds include pyrazole, 1-allyl-3,5-dimethylpyrazole, 3,5-di(2-pyridyl)pyrazole, 3,5-diisopropylpyrazole, 3,5-dimethyl-1-hydroxymethylpyrazole, 3,5-dimethyl-1-phenylpyrazole, 3,5-dimethylpyrazole, 3-amino-5-hydroxypyrazole, 4-methylpyrazole, N-methylpyrazole, 3-aminopyrazole, and 3-aminopyrazole.

Examples of pyrimidine compounds include pyrimidine, 1,3-diphenyl-pyrimidine-2,4,6-trione, 1,4,5,6-tetrahydropyrimidine, 2,4,5,6-tetraaminopyrimidine sulfate, 2,4,5-trihydroxypyrimidine, 2,4,6-triaminopyrimidine, 2,4,6-trichloropyrimidine, 2,4,6-trimethoxypyrimidine, 2,4,6-triphenylpyrimidine, 2,4-diamino-6-hydroxylpyrimidine, 2,4-diaminopyrimidine, 2-acetamidopyrimidine, 2-aminopyrimidine, and 4-aminopyrazolo[3,4-d]pyrimidine.

Examples of imidazole compounds include imidazole, 1,1′-carbonylbis-1H-imidazole, 1,1′-oxalyldiimidazole, 1,2,4,5-tetramethylimidazole, 1,2-dimethyl-5-nitroimidazole, 1,2-dimethylimidazole, 1-(3-aminopropyl)imidazole, 1-butylimidazole, 1-ethylimidazole, 1-methylimidazole, and benzimidazole.

Examples of guanidine compounds include guanidine, 1,1,3,3-tetramethylguanidine, 1,2,3-triphenylguanidine, 1,3-di-o-tolylguanidine, and 1,3-diphenylguanidine.

Examples of thiazole compounds include thiazole, 2-mercaptobenzothiazole, and 2,4-dimethylthiazole.

Examples of tetrazole compounds include tetrazole, 5-methyltetrazole, 5-amino-1H-tetrazole, and 1-(2-dimethylaminoethyl)-5-mercaptotetrazole.

Examples of triazine compounds include triazine, and 3,4-dihydro-3-hydroxy-4-oxo-1,2,4-triazine.

The above-mentioned metal corrosion inhibitor can be added to the polishing composition in an amount of, for example, 0.0001 to 10% by mass, to the silica particles. When the amount of the metal corrosion inhibitor added is within the above range, it is possible to maintain an anti-corrosion effect and improve the stability of the polishing composition.

### <Stability of Polishing Composition: Heat Storage Test>

In a test in which the polishing composition of the present invention is heated and stored at 50° C. for 28 days, it is desirable that the rate of increase in the average secondary particle diameter of the polishing composition after heating and storing at 50° C. for 28 days, which is measured by a dynamic light scattering method, compared to the average secondary particle diameter of the polishing composition before heating and storing, which is measured by a dynamic light scattering method, be low (the particle diameter does not change), and for example, the rate of increase may be less than 5%, or 4% or less, 0 to less than 5%, 0 to 4%, or 0 to 3%.

In a polishing composition that satisfies the above rate of increase, since the particle diameter and shape of the silica particles contained in the polishing composition hardly change even during transportation or storage, the generation of coarse particles due to the aggregation of the silica particles and a decrease in the amount of active components due to the precipitation of the silica particles do not occur, and desired polishing performance can be achieved.

The polishing composition of the present invention can be produced, stored, and transported in the form of a concentrated solution. The silica concentration in the form of the concentrated solution is not particularly limited as long as it is within a range that satisfies the rate of increase in the average secondary particle diameter in the test of heating and storing at 50° C. for 28 days, and may be, for example, 1 to 30% by mass, 5 to 30% by mass, 5 to 25% by mass, or 10 to 25% by mass. When the polishing composition is produced, stored, and transported in the form of the concentrated solution, it is possible to reduce transportation cost and achieve space saving during storage. The concentrated solution can be diluted with any solvent such as pure water immediately before use to adjust the SiO₂ concentration to a predetermined value, for example, 0.1 to 10% by mass, and then subjected to polishing processing. In addition, when the SiO₂ concentration of the concentrated solution is set within a range that satisfies the above rate of increase, it is possible to minimize deterioration of polishing performance due to the aggregation of the silica particles contained in the concentrated solution.

The pH of the concentrated solution can be adjusted to be within a range of 1 to 12, 1 to 6, 3 to 6, 7 to 12, 7 to 10, 8 to 12, 9 to 12, 10 to 12 or 11 to 12.

The polishing composition of the present invention can be used to polish silicon wafers or device wafers. There are polishing devices of a one-sided polishing type and a double-sided polishing type, and either type of device can polish silicon wafers using the polishing composition of the present invention. The silicon wafer polishing step is generally composed of a plurality of polishing stages, including primary polishing that is performed at the beginning of the polishing step and final polishing that is performed after the primary polishing step. Here, the primary polishing and the final polishing may each be performed in two separate stages. The polishing composition of the present invention may be used in both the primary polishing and the final polishing, or the polishing composition of the present invention may be used in only one of the primary polishing and the final polishing. The polishing composition of the present invention may be used by circulating it in the polishing device in each polishing step or may be used as a flowing solution for one-time use. In addition, the polishing composition of the present invention can also be used for device wafer CMP polishing. The silica particle dispersion of the present invention can be suitably used in the polishing composition.

### EXAMPLES

Hereinafter, the present invention will be described in more detail with Examples. However, the present invention is not limited thereto.

### 1) Synthesis of Colloidal Silica Dispersion

### (Synthesis Example 1) Synthesis of Colloidal Silica Dispersion A

As a raw material water-soluble alkali metal silicate, a JIS No. 3 sodium silicate aqueous solution was prepared. In the main components of the sodium silicate aqueous solution excluding water, the SiO₂ concentration was 28.8% by mass, and the Na₂O concentration was 9.47% by mass.

The sodium silicate aqueous solution was diluted with pure water to prepare a sodium silicate aqueous solution (a) having a SiO₂ concentration of 4% by mass.

Next, the sodium silicate aqueous solution (a) was passed through a column filled with a hydrogen-type strongly acidic cation exchange resin (product name, Amberlite IR-120B) at a space velocity of 4.5 per hour, cations were removed, and thereby an activated silicic acid aqueous solution was prepared.

A 10% by mass sodium hydroxide aqueous solution was added to the obtained activated silicic acid aqueous solution, the pH was adjusted to 8.5 to 9.5, and thereby a stabilized activated silicic acid aqueous solution was obtained. The SiO₂ concentration of the obtained stabilized activated silicic acid aqueous solution was 3.2% by mass.

2,400 g of the stabilized activated silicic acid aqueous solution obtained above was put into a reaction device including a stirrer, a heating device and the like in a SUS pressure-resistant container with an inner capacity of 3 L, and the liquid temperature in the container was adjusted to 130 to 150° C. by heating. After the temperature in the container reached 130 to 150° C., heating was performed for 2 hours and 30 minutes while keeping the temperature in the container at 130 to 150° C., and thereby a colloidal silica dispersion (precursor silica sol) having an average primary particle diameter of 10 to 15 nm was obtained.

The obtained colloidal silica dispersion was concentrated at room temperature using a commercially available ultrafiltration device having a polysulfone ultrafiltration membrane with a cut-off molecular weight of 200,000 (product name Q2000 150E, commercially available from Advantec Co., Ltd.) attached thereto so that the SiO₂ concentration was 33% by mass, and thereby a precursor silica sol with an adjusted SiO₂ concentration was obtained.

The precursor silica sol with the adjusted SiO₂ concentration was passed through a column filled with a hydrogen-type strongly acidic cation exchange resin (product name, Amberlite IR-120B) at a space velocity of 10 per hour, cations were removed, a 10% by mass sodium hydroxide aqueous solution was added to the obtained dispersion, the pH was adjusted to 7 to 8, and thereby a precursor silica sol with an adjusted pH was obtained.

The precursor silica sol with the adjusted SiO₂ concentration and pH obtained above was put into a reaction device including a stirrer, a heating device and the like in a SUS pressure-resistant container with an inner capacity of 3 L, and the liquid temperature in the container was adjusted to 220 to 240° C. by heating. After the temperature in the container reached 220 to 240° C., heating was performed for 2 hours and 20 minutes while keeping the temperature in the container at 220 to 240° C., and thereby a colloidal silica dispersion A was obtained.

### (Synthesis Example 2) Synthesis of Colloidal Silica Dispersion B

A colloidal silica dispersion B was obtained in the same operation as in Synthesis Example 1 except that the precursor silica sol with an adjusted SiO₂ concentration and pH was heated at 210 to 230° C. in a SUS pressure-resistant container.

### (Synthesis Example 3) Synthesis of Colloidal Silica Dispersion C

The colloidal silica dispersion B obtained in Synthesis Example 2 was passed through a column filled with a hydrogen-type strongly acidic cation exchange resin (product name, Amberlite IR-120B) at a space velocity of 10 per hour, cations were removed, a 10% by mass sodium hydroxide aqueous solution was added to the obtained dispersion, and the pH was adjusted to 9 to 10.

2,400 g of the colloidal silica dispersion B with the pH adjusted to 9 to 10 was put into a reaction device including a stirrer, a heating device and the like in a SUS pressure-resistant container with an inner capacity of 3 L, and the liquid temperature in the container was adjusted to 190 to 210° C. by heating. After the temperature in the container reached 190 to 210° C., heating was performed for 12 hours while keeping the temperature in the container at 190 to 210° C., and thereby a colloidal silica dispersion C was obtained.

### (Synthesis Example 4) Synthesis of Colloidal Silica Dispersion D

A colloidal silica dispersion D was obtained in the same operation as in Synthesis Example 3 except that the colloidal silica dispersion B with the pH adjusted to 9 to 10 was heated at 170 to 190° C. for 72 hours in a SUS pressure-resistant container.

### (Synthesis Example 5) Synthesis of Colloidal Silica Dispersion E

A colloidal silica dispersion E was obtained in the same operation as in Synthesis Example 1 except that the precursor silica sol with an adjusted SiO₂ concentration and pH was heated at 230 to 250° C. for 6 hours in a SUS pressure-resistant container.

### (Synthesis Example 6) Synthesis of Colloidal Silica Dispersion F

A colloidal silica dispersion F was obtained in the same operation as in Synthesis Example 1 except that the precursor silica sol with an adjusted SiO₂ concentration and pH was heated at 240 to 260° C. for 9 hours in a SUS pressure-resistant container.

### (Synthesis Example 7) Synthesis of Colloidal Silica Dispersion G

A colloidal silica dispersion G was synthesized in the same method as in Synthesis Example 4 in WO 2020/091000.

Specifically, 8% by mass sulfuric acid was added to the activated silicic acid aqueous solution obtained by the same operation as in above-mentioned Synthesis Example 1, the pH was adjusted to 2 to 3, and thereby an activated silicic acid aqueous solution stabilized with sulfuric acid was obtained. Pure water was added to the activated silicic acid aqueous solution stabilized with sulfuric acid obtained above with stirring, a 10% by mass potassium hydroxide aqueous solution was then added, the SiO₂ concentration was adjusted to 3.2% by mass, the pH was adjusted to 12.0, and the liquid temperature in the container was then adjusted to 110 to 130° C. in a reaction device including a stirrer, a heating device and the like in a SUS pressure-resistant container with an inner capacity of 3 L. After the temperature in the container reached 110 to 130° C., while keeping the inside of the container at 110 to 130° C., the activated silicic acid aqueous solution stabilized with sulfuric acid obtained above was continuously supplied as a supply solution until the pH of the reaction solution reached 11.4. After the activated silicic acid aqueous solution stabilized with sulfuric acid was supplied, the temperature in the container was kept at 110° C., the reaction proceeded for 1 hour, and additionally, the activated silicic acid aqueous solution stabilized with sulfuric acid was then continuously supplied as a supply solution until the pH of the reaction solution reached 11.1. After the activated silicic acid aqueous solution stabilized with sulfuric acid was supplied, while keeping the temperature in the container at 110 to 130° C., heating was performed for 2 more hours, and thereby a reaction solution was obtained.

The obtained reaction solution was concentrated at room temperature using a commercially available ultrafiltration device having a polysulfone ultrafiltration membrane with a cut-off molecular weight of 200,000 (product name Q2000 150E, commercially available from Advantec Co., Ltd.) attached thereto so that the SiO₂ concentration was 40% by mass, and thereby a colloidal silica dispersion G was obtained.

### (Synthesis Example 8) Synthesis of Colloidal Silica Dispersion H

2,400 g of a colloidal silica dispersion (product name PL-3, commercially available from Fuso Chemical Co., Ltd.) was put into a reaction device including a stirrer, a heating device and the like in a SUS pressure-resistant container with an inner capacity of 3 L, and the temperature was adjusted to 190 to 210° C. After the temperature in the container reached 190 to 210° C., heating was performed for 1 hour while keeping the temperature in the container at 190 to 210° C., and thereby a colloidal silica dispersion H was obtained.

### (Synthesis Example 9) Synthesis of Colloidal Silica Dispersion I

A colloidal silica dispersion I was obtained in the same operation as in Synthesis Example 6 except that the heating time when the temperature in the container was kept at 190 to 210° C. was 5 hours.

### 2) Analysis of Colloidal Silica Dispersion and Silica Particles

The colloidal silica dispersions A to I prepared above, as well as a colloidal silica dispersion (product name Snowtex XL, commercially available from Nissan Chemical Corporation), and a colloidal silica dispersion (product name PL-3, commercially available from Fuso Chemical Co., Ltd.) were subjected to the following analysis.

### 2-1) Method of Measuring Particle Diameter

The average primary particle diameter of silica particles was measured by the nitrogen gas adsorption method.

Pure water was added to each colloidal silica dispersion to prepare a sample whose SiO₂ concentration was adjusted to 10% by mass. Next, 10 mL of a hydrogen-type strongly acidic cation exchange resin (product name, Amberlite IR-120B) was added to 5 g of the obtained sample, the mixture was stirred for 30 minutes, and thereby a sample from which cations had been removed was obtained.

The obtained sample was filtered through a nylon mesh, the cation exchange resin was removed, heating was then performed at 290° C. for 1 hour using an electric furnace (product name DX302, commercially available from Yamato Scientific Co., Ltd.) under atmospheric atmosphere, and the solvent was removed to obtain a dried product. The dried product was ground in an agate mortar for 10 minutes to obtain a heat-dried powder.

The heat-dried powder was used as a measurement sample, a specific surface area value S_{N2} of the measurement sample was measured using a specific surface area measurement device (product name Monosorb, commercially available from Quantachrome Instruments, Japan, Inc.) based on nitrogen gas using the nitrogen gas adsorption method (BET method), and the average primary particle diameter was calculated from the obtained specific surface area value.

In addition, the average secondary particle diameter of the silica particles was measured using Zetasizer Nano (product name, commercially available from Malvern Panalytical Ltd.) by the dynamic light scattering method (DLS) as follows. 0.1 g of a colloidal silica dispersion was dispensed in a polystyrene cell having an optical path length of 10 mm, a 0.15% by mass sodium chloride aqueous solution was additionally added, and a colloidal silica dispersion whose silica concentration was adjusted so that the count rate when the attenuator indicated 7 was 200 to 400 kcps was obtained. The amount of the prepared colloidal silica dispersion added to the cell was adjusted so that the height of the liquid level from the bottom of the cell was about 1 cm, and the average secondary particle diameter of the silica was measured under conditions of an attenuator of 7 and a temperature of 22.0° C.

### 2-2) Pulsed NMR Analysis Method

Pure water was added to each colloidal silica dispersion to prepare a sample whose SiO₂ concentration was adjusted to 5% by mass. 0.77 mL of the sample was put into a glass NMR tube, and the relaxation time of the sample was measured using a pulsed NMR device (product name Acorn area, commercially available from Xigo nanotools) under the following conditions.
Magnetic field: 0.3 T
Measurement frequency: 13 MHz
Measurement nucleus: ¹H NMR
Measurement method: CPMG pulse sequence method
Temperature: 30° C.

The reciprocal of the relaxation time of the colloidal silica dispersion obtained by measurement under the above conditions was defined as Rav, the reciprocal of the relaxation time of pure water obtained by measurement under the same conditions was defined as Rb, and the Rsp value of each colloidal silica dispersion was calculated by the following formula.

Rsp=(Rav−Rb)/(Rb)

### 2-3) Method of Quantifying Silanol Group Amount

Pure water was added to each colloidal silica dispersion to prepare a sample whose SiO₂ concentration was adjusted to 10% by mass. Next, 20 mL of a hydrogen-type strongly acidic cation exchange resin (product name, Amberlite IR-120B) was added to 100 g of the obtained sample, and the mixture was stirred for 30 minutes to remove cations. The obtained sample was filtered through a nylon mesh, the cation exchange resin was removed, 20 mL of a hydroxyl group type strongly basic anion exchange resin (product name, Amberlite IRA-410) was then added, and the mixture was stirred for 30 minutes to remove anions. The obtained sample was filtered through a nylon mesh, the anion exchange resin was removed, 20 mL of a hydrogen-type strongly acidic cation exchange resin (product name, Amberlite IR-120B) was then added again, and the mixture was stirred for 30 minutes to remove cations. The obtained sample was filtered through a nylon mesh, the cation exchange resin was removed, and thereby a dispersion from which cations and anions had been removed was obtained.

The dispersion from which the ions had been removed was put into an eggplant flask with a capacity of 300 mL. The eggplant flask containing the dispersion was immersed for 10 minutes in ethanol that was cooled to −70° C. to −80° C. by adding dry ice, and thereby a frozen dispersion was obtained. The frozen dispersion was left to stand at room temperature under a vacuum pressure of 5 Pa or less using a freezing and drying device (product name FDU-2100, commercially available from TOKYO RIKAKIKAI Co., Ltd.), and frozen water was sublimated to obtain a freeze-dried sample. The freeze-dried sample was ground in an agate mortar for 10 minutes to obtain a freeze-dried powder.

Using a thermogravimetry-differential thermal analyzer (product name TG-DTA2000SA, commercially available from Bruker), the freeze-dried powder was heated, and the mass loss amount when the temperature was increased from room temperature to 700° C. was measured.

Specifically, 5 to 10 mg of the freeze-dried powder was put into a platinum container, and the initial sample mass was set as M0. The platinum container containing the freeze-dried powder was placed in the thermogravimetry-differential thermal analyzer and heated in a nitrogen gas atmosphere from room temperature to 700° C. at a heating rate of 10° C./min. Here, the flow rate of nitrogen gas was 100 cc/min. The mass loss amount M1 when the temperature in the device reached 200° C. was defined as the mass loss due to the removal of water adsorbed on the surfaces of the silica particles contained in the freeze-dried powder, the value obtained by subtracting M1 from the mass loss amount M2 when the temperature in the device reached 700° C. was regarded as the mass loss due to the removal of water generated by dehydration condensation of silanol groups, and the silanol group amount in the silica particles was calculated using the following formula.

$$S ilanol group amount ( m mol / g ) = 2 \times ( M 2 - M 1 ) \div 18 \div ( M 0 - M 1 ) \times 1000$$

### 2-4) Method of Measuring Dry Density

The freeze-dried powder of the colloidal silica dispersion prepared in the same manner as in 2-3) was used as a dry density measurement sample.

Using a dry automatic density measurement device (product name AccuPyc II TEC, commercially available from Micromeritics Instrument Corporation), the measurement sample was filled into a 1 cm³ aluminum cell to fill 80% of the cell, and the dry density of the silica particles was measured using He gas under conditions at 25° C. by gas displacement method.

### 2-5) Method of Measuring Ratio of Specific Surface Area Based on Water Vapor Adsorption Method to Specific Surface Area Based on Nitrogen Gas Adsorption Method

Pure water was added to each colloidal silica dispersion to prepare a sample whose SiO₂ concentration was adjusted to 10% by mass. Next, 20 mL of a hydrogen-type strongly acidic cation exchange resin (product name, Amberlite IR-120B) was added to 100 g of the obtained sample, and the mixture was stirred for 30 minutes to remove cations. The obtained sample was filtered through a nylon mesh, the cation exchange resin was removed, 20 mL of a hydroxyl group type strongly basic anion exchange resin (product name, Amberlite IRA-410) was then added, and the mixture was stirred for 30 minutes to remove anions. The obtained sample was filtered through a nylon mesh, the anion exchange resin was removed, 20 mL of a hydrogen-type strongly acidic cation exchange resin (product name, Amberlite IR-120B) was then added again, and the mixture was stirred for 30 minutes to remove cations. The obtained sample was filtered through a nylon mesh, the cation exchange resin was removed, and thereby a dispersion from which cations and anions had been removed was obtained.

20 g of the dispersion was weighed out into an alumina petri dish and heated using a hot plate at 140° C. for 2 hours to remove water. In addition, the obtained silica powder was heated in an electric furnace at 290° C. for 1 hour and completely dried. The obtained silica powder was ground in an agate mortar for 10 minutes to obtain a heat-dried powder.

Using a water vapor adsorption and desorption measurement device (product name Q5000 SA, commercially available from TA Instruments Japan Inc.), under the following conditions, the water vapor adsorption amount of the heat-dried powder was measured in an environment in which the relative humidity was changed from 10% to 90%. The flow rate of nitrogen gas was 200 mL/min, and the measurement temperature was 25° C. Here, immediately before the measurement, the heat-dried powder was dried in an electric furnace at 200° C. for 1 hour, the adsorbed water was removed, and 10 mg of the sample powder was then weighed out in a platinum container within 5 minutes and used for the measurement.

A BET plot was created from the relationship between the obtained water vapor adsorption amount and the relative humidity, and an approximate straight line was obtained in a relative humidity range of 0.20 to 0.35. The slope WM of the straight line was taken as the water vapor adsorption amount per 1 g of the measurement sample, and the specific surface area S_{H2O} of the measurement sample based on the water vapor adsorption method was calculated using the following formula.

$$\begin{matrix}{S}_{H 2 O} = {W}_{M} \times {N}_{A} \times {A}_{M} \div {M}_{H 2 O} \\ = {W}_{M} \times 6.02 \times 1 {0}^{23} \times 10.8 \times 1 {0}^{- 20} \div 18 \\ = {W}_{M} \times 3612\end{matrix}$$

Here, N_{A} is the Avogadro's number, A_{M} is the cross-sectional area occupied by one water molecule, and M_{H2O} is the molecular weight of water.

The ratio S_{H2O}/S_{N2} was calculated from the specific surface area S_{H2O} based on the water vapor adsorption method measured above and the specific surface area S_{N2} based on the nitrogen gas adsorption method obtained in 2-1).

### 3) Preparation of Polishing Composition

### Example 1

Using the colloidal silica dispersion A obtained in Synthesis Example 1, each reagent and pure water were added so that the concentration of the silica particles derived from the colloidal silica dispersion A was 20.5% by mass, the concentration of an ethylenediaminetetraacetic acid tetrasodium salt was 0.65% by mass, the concentration of tetramethylammonium hydroxide (TMAH) was 1.0% by mass, and the concentration of potassium carbonate was 1.5% by mass, the mixture was stirred for 30 minutes, and thereby a polishing composition of Example 1 was obtained.

### Example 2

A polishing composition of Example 2 was prepared in the same manner as in Example 1 except that the colloidal silica dispersion B obtained in Synthesis Example 2 was used.

### Example 3

A polishing composition of Example 3 was prepared in the same manner as in Example 1 except that the colloidal silica dispersion C obtained in Synthesis Example 3 was used.

### Example 4

A polishing composition of Example 4 was prepared in the same manner as in Example 1 except that the colloidal silica dispersion D obtained in Synthesis Example 4 was used.

### Example 5

A polishing composition of Example 5 was prepared in the same manner as in Example 1 except that the colloidal silica dispersion E obtained in Synthesis Example 5 was used.

### Example 6

A polishing composition of Example 6 was prepared in the same manner as in Example 1 except that the colloidal silica dispersion F obtained in Synthesis Example 6 was used.

### Comparative Example 1

A polishing composition of Comparative Example 1 was prepared in the same manner as in Example 1 except that a colloidal silica dispersion (product name Snowtex XL, commercially available from Nissan Chemical Corporation) was used as the colloidal silica dispersion.

### Comparative Example 2

A polishing composition of Comparative Example 2 was prepared in the same manner as in Example 1 except that the colloidal silica dispersion G obtained in Synthesis Example 7 was used.

### Comparative Example 3

A polishing composition of Comparative Example 3 was prepared in the same manner as in Example 1 except that a colloidal silica dispersion (product name PL-3, commercially available from Fuso Chemical Co., Ltd.) was used as the colloidal silica dispersion.

### Comparative Example 4

A polishing composition of Comparative Example 4 was prepared in the same manner as in Example 1 except that the colloidal silica dispersion H obtained in Synthesis Example 8 was used.

### Comparative Example 5

A polishing composition of Comparative Example 5 was prepared in the same manner as in Example 1 except that the colloidal silica dispersion I obtained in Synthesis Example 9 was used.

### Evaluation

### (Storage Stability Test)

Immediately after the polishing compositions of Examples 1 to 6 and Comparative Examples 1 to 5 were prepared, the average secondary particle diameter of the silica particles was measured. Each polishing composition was stored in a commercially available thermostatic chamber set at 50° C., and after 28 days, the average secondary particle diameter was measured. Here, the average secondary particle diameter was measured according to the procedure described in the above 2-1) Method of measuring particle diameter in 2) Analysis of colloidal silica dispersion and silica particle.

When the rate of change in the average secondary particle diameter (rate of increase) after storage at 50° C. was less than 5% compared with the average secondary particle diameter immediately after each polishing composition was prepared (before storage at 50° C.), the storage stability was determined to be good.

### (Polishing Test)

The polishing compositions of Examples 1 to 6 and Comparative Examples 1 to 5 were diluted 20-fold on a mass basis with pure water to obtain polishing test compositions.

A polishing test was performed using the polishing test composition under the following polishing conditions. A wafer to be polished was a single crystal silicon wafer, with a diameter of 200 mm, P-type conductivity, a crystal orientation of Miller index <100>, and a resistivity of 100 Ω·cm or less. The polishing test composition was supplied in a circulation manner, and the liquid temperature was 23 to 25° C. The polishing time was 60 minutes per batch, and three batches of polishing were performed using the same polishing pad. The amount of a polishing solution was 25 kg, and neither replenishment of a new polishing solution nor pH adjustment was performed between batches.

### (Polishing Conditions)

Polishing machine: product name double-sided polishing machine 13BF (commercially available from Hamai Co., Ltd.)
Polishing pad: product name LP-57 (commercially available from JH-RHODES), a groove width of 2 mm, and a groove pitch of 20 mm
Polishing load: 150 g/cm²
Lower platen rotation speed: 6.6 rpm
Upper platen rotation speed: 20 rpm
Rotation ratio: 3.3
Number of pieces polished: 3 sets of 1 wafer/carrier were prepared, and a total of 3 pieces were polished simultaneously
Amount of polishing test composition supplied: 6.4 L/min
Polishing time: 60 min
Carrier: epoxy glass carrier (a thickness of 0.70 mm)
   (Conditions for Evaluating Wafer after Polishing)

The polishing rate was calculated by measuring the thickness of the wafer before and after polishing using a laser displacement meter (product name SI-F1000, commercially available from Keyence Corporation), subtracting the thickness of the wafer after polishing from the thickness of the wafer before polishing, and dividing the result by a polishing time of 60 min.

The surface roughness was obtained by using an optical interference microscope system (product name BW-M7000, commercially available from Nikon Solutions Co., Ltd) with a 100× objective lens, and measuring the root-mean-square height in a 111 m square area in the center of the wafer.

### Results

Table 1 shows the physical properties of the colloidal silica dispersions used in Examples 1 to 6 and Comparative Examples 1 to 5, and Table 2 shows the results of the polishing test and the results of the storage stability test of the polishing compositions.

TABLE 1

| | | Average | Average | | | | |
|---|---|---|---|---|---|---|---|
| | | primary | secondary | | Silanol | | |
| | | particle | particle | | group | Dry | |
| Silica | | diameter | diameter | Rsp | amount | density | S_{H2O}/S_{N2} |
| dispersion | | (nm) | (nm) | (—) | (mmol/g) | (g/cm³) | (—) |
| Example 1 | Dispersion | 45 | 65 | 0.12 | 0.80 | 2.28 | 0.35 |
| | A | | | | | | |
| Example 2 | Dispersion | 37 | 55 | 0.14 | 1.23 | 2.27 | 0.37 |
| | B | | | | | | |
| Example 3 | Dispersion | 42 | 57 | 0.07 | 0.77 | 2.29 | 0.37 |
| | C | | | | | | |
| Example 4 | Dispersion | 40 | 57 | 0.07 | 0.76 | 2.29 | 0.35 |
| | D | | | | | | |
| Example 5 | Dispersion | 60 | 83 | 0.09 | 0.22 | 2.25 | 0.32 |
| | E | | | | | | |
| Example 6 | Dispersion | 74 | 98 | 0.07 | 0.36 | 2.26 | 0.29 |
| | F | | | | | | |
| Comparative | Snowtex | 42 | 75 | 0.26 | 1.87 | 2.19 | 0.79 |
| Example 1 | XL | | | | | | |
| Comparative | Dispersion | 43 | 68 | 0.37 | 1.60 | 2.21 | 0.67 |
| Example 2 | G | | | | | | |
| Comparative | PL-3 | 36 | 67 | 1.67 | 3.14 | 2.11 | 2.11 |
| Example 3 | | | | | | | |
| Comparative | Dispersion | 37 | 65 | 0.42 | 2.09 | 2.16 | 1.63 |
| Example 4 | H | | | | | | |
| Comparative | Dispersion | 36 | 65 | 0.29 | 1.95 | 2.17 | 1.25 |
| Example 5 | I | | | | | | |

TABLE 2

| | | | Storage stability |
|---|---|---|---|
| | | | test |
| | Polishing test results | | Rate of change (%) |
| | Polishing | Surface | in average |
| | rate | roughness | secondary particle |
| | (μm/min) | (nm) | diameter |
| Example 1 | 0.33 | 1.16 | 2 |
| Example 2 | 0.34 | 1.09 | 0 |
| Example 3 | 0.34 | 1.12 | 2 |
| Example 4 | 0.34 | 1.16 | 0 |
| Example 5 | 0.32 | 1.09 | 1 |
| Example 6 | 0.32 | 1.14 | 0 |
| Comparative | 0.33 | 1.16 | 40 |
| Example 1 | | | |
| Comparative | 0.32 | 1.13 | 40 |
| Example 2 | | | |
| Comparative | 0.32 | 1.15 | 212 |
| Example 3 | | | |
| Comparative | 0.32 | 1.17 | 7 |
| Example 4 | | | |
| Comparative | 0.32 | 1.16 | 6 |
| Example 5 | | | |

As shown in Table 2, the polishing rate was 0.32 to 0.34 m/min in Examples 1 to 6, and 0.32 to 0.33 m/min in Comparative Examples 1 to 5, showing equivalent performance. The surface roughness was 1.09 to 1.16 nm in Examples 1 to 6, and 1.13 to 1.17 nm in Comparative Examples 1 to 5, also showing equivalent performance.

This is thought to be because, since the silica particles based on the colloidal silica dispersions A to F with an Rsp value of 0.07 to 0.14 had sufficient water affinity to maintain the dispersibility of the silica particles in the polishing composition, it was possible to achieve a polishing rate and surface roughness at which the surface of the silicon wafer that was altered by alkaline components such as TMAH and potassium carbonate was uniformly and efficiently scraped off in the polishing test.

On the other hand, in the storage stability test, in Examples 1 to 6 in which the Rsp value of the colloidal silica dispersion used to prepare the polishing composition was within a certain specific range, the rate of change in the average secondary particle diameter was 0 to 2%, which was a good result. This is thought to be because, in the silica particles based on the colloidal silica dispersion with an Rsp value of 0.07 to 0.14, there were few hydroxy groups (OH⁻) bound near the surfaces of the particles, excessive dissolution of the surfaces of the silica particles due to hydroxy groups was minimized, and thus the aggregation of the silica particles was minimized, and the storage stability was excellent.

On the other hand, it was thought that, in the polishing compositions of Comparative Examples 1 to 5 using silica particles based on a colloidal silica dispersion in which the Rsp value was not within a certain specific range, many hydroxy groups were present near the surfaces of the silica particles. Accordingly, it was thought that the silica particles were easily dissolved, the Si—O—Si bonds on the surfaces of the silica particles were broken, the silica particles became active, the silica particles easily aggregated together, and the storage stability decreased.

According to the examples of the present invention, it was confirmed that, in the silica sol used in the polishing composition, when silica particles having an Rsp value obtained by pulsed NMR measurement within a specific numerical value range were used, a high polishing rate could be obtained when these silica particles were used as the polishing composition to polish silicon wafers, and the storage stability could be improved.

Therefore, the polishing composition of the present invention can be used not only as a silicon wafer polishing agent but also as a device wafer CMP polishing agent because it has a high polishing rate and storage stability.

### INDUSTRIAL APPLICABILITY

In the silica sol used in the polishing composition, when silica particles having a specific Rsp value obtained by pulsed NMR are used, a high polishing rate can be obtained when used to polish silicon wafers, and the storage stability of the polishing composition can be improved.

1. A polishing composition comprising a silica particle aqueous dispersion,
wherein the following Rsp value derived from a relaxation time obtained by pulsed NMR measurement of the silica particle aqueous dispersion and pure water is 0.01 or more and less than 0.15:
$$Rsp = ( R a v - Rb ) / ( Rb )$$
wherein Rav is a reciprocal of the relaxation time of the silica particle aqueous dispersion having a silica concentration of 5% by mass, and Rb is a reciprocal of the relaxation time of the pure water.

2. The polishing composition according to claim 1,
wherein silica particles contained in the silica particle aqueous dispersion have an average secondary particle diameter of 40 to 200 nm, which is measured by a dynamic light scattering method, and an average primary particle diameter of 20 to 100 nm, which is measured by a nitrogen gas adsorption method.

3. The polishing composition according to claim 1,
wherein, regarding a silica particle powder obtained by freezing a treatment solution in which ions are exchanged by bringing a cation exchange resin, an anion exchange resin, and a cation exchange resin into contact with the silica particle aqueous dispersion in an order of the cation exchange resin, the anion exchange resin, and the cation exchange resin at −70° C. to −80° C., additionally performing freeze-drying at room temperature under a pressure of 5 Pa or less, and removing a dispersion medium, a silanol group amount calculated from a mass loss amount when heated from room temperature to 700° C. in thermogravimetric analysis and a molecular weight of water molecules using the following formula is 0.1 to 1.5 mmol/g:
$$silanol group amount ( m mol / g ) = 2 \times ( M 2 - M 1 ) \div {M}_{H 2 O} \div ( M 0 - M 1 ) \times 1000$$
wherein M0 is a mass of a silica particle powder subjected to thermogravimetric analysis before heating, M1 is a mass loss amount when a temperature reaches 200° C., M2 is the mass loss amount when the temperature reaches 700° C., and M_{H2O} is the molecular weight of water molecules.

4. The polishing composition according to claim 1,
wherein, in a silica particle powder obtained by freezing a treatment solution in which ions are exchanged by bringing a cation exchange resin, an anion exchange resin, and a cation exchange resin into contact with the silica particle aqueous dispersion in an order of the cation exchange resin, the anion exchange resin, and the cation exchange resin at −70° C. to −80° C., additionally performing freeze-drying at room temperature under a pressure of 5 Pa or less, and removing a dispersion medium, a density measured by dry density measurement is 2.20 to 2.35 g/cm³.

5. The polishing composition according to claim 1,
wherein, regarding a silica particle powder obtained by heating a treatment solution in which ions are exchanged by bringing a cation exchange resin, an anion exchange resin, and a cation exchange resin into contact with the silica particle aqueous dispersion in an order of the cation exchange resin, the anion exchange resin, and the cation exchange resin at 140° C. for 2 hours, additionally performing heating at 290° C. for 1 hour, and removing a dispersion medium, a ratio (S_{H2O}/S_{N2}) of a specific surface area (S_{H2O}) based on a water vapor adsorption method to a specific surface area (S_{N2}) based on a nitrogen gas adsorption method is 0.10 to 0.65.

6. The polishing composition according to claim 1,
wherein the silica particle aqueous dispersion has a thermal history of being at a temperature of 140° C. or higher and lower than 260° C.

7. The polishing composition according to claim 1,
wherein concentration of the silica particles is 1 to 40% by mass.

8. The polishing composition according to claim 1, further comprising at least one additive selected from the group consisting of an acidic compound, a basic compound, a water-soluble compound, a chelating agent, an oxidizing agent, and a metal corrosion inhibitor.

9. The polishing composition according to claim 8,
wherein the basic compound is at least one basic compound selected from the group consisting of alkali metal hydroxides, alkali metal carbonates, alkali metal bicarbonates, and nitrogen-containing basic compounds.

10. The polishing composition according to claim 8,
wherein the chelating agent is an aminocarboxylic acid-based chelating agent or a phosphonic acid-based chelating agent.

11. The polishing composition according to claim 1,
wherein the polishing composition has a pH of 1 to 12.

12. The polishing composition according to claim 1,
wherein, in a test in which the polishing composition is heated and stored at 50° C. for 28 days,
a rate of increase in the average secondary particle diameter of the polishing composition after heating and storing at 50° C. for 28 days, which is measured by a dynamic light scattering method, compared to the average secondary particle diameter of the polishing composition before heating and storing at 50° C. for 28 days, which is measured by a dynamic light scattering method, is less than 5%.

13. The polishing composition according to claim 1,
wherein the polishing composition is used to polish silicon wafers or device wafers.

14. A method of producing the polishing composition according to claim 1, comprising:
a step of preparing a colloidal silica dispersion as a precursor; and
a step of obtaining the silica particle aqueous dispersion by heating the precursor at a temperature of 140° C. or higher and lower than 260° C.

15. A silica particle dispersion comprising a solvent and silica particles,
wherein the following Rsp value derived from a relaxation time obtained by pulsed NMR measurement of the silica particle dispersion and a blank solution is 0.01 or more and less than 0.15:
$$Rsp = ( R a v - Rb ) / ( Rb )$$
wherein Rav is a reciprocal of the relaxation time of the silica particle dispersion having a silica concentration of 5% by mass, and Rb is a reciprocal of the relaxation time of the blank solution.

16. The silica particle dispersion according to claim 15,
wherein the solvent includes water.

17. The silica particle dispersion according to claim 15,
wherein the silica particles have an average secondary particle diameter of 40 to 200 nm, which is measured by a dynamic light scattering method, and an average primary particle diameter of 20 to 100 nm, which is measured by a nitrogen gas adsorption method.

18. The silica particle dispersion according to claim 15,
wherein, regarding a silica particle powder obtained by freezing a treatment solution in which ions are exchanged by bringing a cation exchange resin, an anion exchange resin, and a cation exchange resin into contact with the silica particle dispersion in an order of the cation exchange resin, the anion exchange resin, and the cation exchange resin at −70° C. to −80° C., additionally performing freeze-drying at room temperature under a pressure of 5 Pa or less, and removing a dispersion medium, a silanol group amount calculated from a mass loss amount when heated from room temperature to 700° C. in thermogravimetric analysis and a molecular weight of water molecules using the following formula is 0.1 to 1.5 mmol/g:
$$silanol group amount ( m mol / g ) = 2 \times ( M 2 - M 1 ) \div {M}_{H 2 O} \div ( M 0 - M 1 ) \times 1000$$
wherein M0 is a mass of a silica particle powder subjected to thermogravimetric analysis before heating, M1 is a mass loss amount when a temperature reaches 200° C., M2 is the mass loss amount when the temperature reaches 700° C., and M_{H2O} is the molecular weight of water molecules.

19. The silica particle dispersion according to claim 15,
wherein, in a silica particle powder obtained by freezing a treatment solution in which ions are exchanged by bringing a cation exchange resin, an anion exchange resin, and a cation exchange resin into contact with the silica particle dispersion in an order of the cation exchange resin, the anion exchange resin, and the cation exchange resin at −70° C. to −80° C., additionally performing freeze-drying at room temperature under a pressure of 5 Pa or less, and removing a dispersion medium, a density measured by dry density measurement is 2.20 to 2.35 g/cm³.

20. The silica particle dispersion according to claim 15,
wherein, regarding a silica particle powder obtained by heating a treatment solution in which ions are exchanged by bringing a cation exchange resin, an anion exchange resin, and a cation exchange resin into contact with the silica particle dispersion in an order of the cation exchange resin, the anion exchange resin, and the cation exchange resin at 140° C. for 2 hours, additionally performing heating at 290° C. for 1 hour, and removing a dispersion medium, a ratio (S_{H2O}/S_{N2}) of a specific surface area (S_{H2O}) based on a water vapor adsorption method to a specific surface area (S_{N2}) based on a nitrogen gas adsorption method is 0.10 to 0.65.

21. The silica particle dispersion according to claim 15,
wherein the silica particle dispersion has a thermal history of being at a temperature of 140° C. or higher and lower than 260° C.

22. The silica particle dispersion according to claim 15,
wherein concentration of the silica particles is 1 to 40% by mass.

23. A method of producing the silica particle dispersion according to claim 15, comprising:
a step of preparing a colloidal silica dispersion as a precursor; and
a step of obtaining the silica particle dispersion by heating the precursor at a temperature of 140° C. or higher and lower than 260° C.
